(19) United States
(12) Patent Application Publication
(10) Pub. No.: US 2010/0141669 A1
(43) Pub. Date: Jun. 10, 2010

(54) Display Apparatus

(75) Inventor: Takashi Sadahiro, Tokyo (JP)

Correspondence Address: BIRCH STEWART KOLASCH & BIRCH, PO BOX 747, FALLS CHURCH, VA, 22040-0747, US

(73) Assignee: MITSUBISHI ELECTRIC CORPORATION, Tokyo (JP)

(21) Appl. No.: 11/989,434

(22) PCT Filed: May 16, 2006
(86) PCT No.: PCT/JP2006/309738

§ 371 Date: Jan. 25, 2008

(30) Foreign Application Priority Data
Sep. 26, 2005 (JP) 2005-278355

(51) Int. Cl. G09G 5/02

(52) U.S. Cl. 345/589

(57) ABSTRACT

A display apparatus 10 for displaying various information items on its screen has a temperature detecting section 28 for detecting the temperature within the display apparatus. If the temperature detected by the temperature detecting section exceeds a preset first temperature, a control section 26 carries out luminance correction control of the screen. In addition, it controls a video generating section 22 and video processing section 21 so as to perform screen display control by processing the various information items, thereby improving the viewability.

### TECHNICAL FIELD

The present invention relates to a display apparatus that carries out display control of a display means (display section) of a liquid crystal display (LCD) and the like, and more particularly to a display apparatus that is mounted on a means of conveyance such as a vehicle and performs display control of the display section in response to ambient temperature.

### BACKGROUND ART

Generally, a display apparatus using LCD or the like has a power source circuit and a backlight which work as a heating source within the apparatus itself. Thus, according to environmental conditions in which the display apparatus is used such as very high ambient temperature (environment temperature) of the display apparatus, the interior of the display apparatus can become very high. In particular, as for the display apparatus mounted on a vehicle, since a heating source is placed near the display apparatus and the vehicle is usually closed, the display apparatus is used under severe environmental conditions. When the temperature of the display apparatus becomes high within itself, various components of the display apparatus can suffer performance degradation or damage, thereby being unable to perform normal display operation.

To prevent such malfunctioning, if the internal temperature (ambient temperature) of the display apparatus exceeds a prescribed temperature, a warning is displayed on its screen, and then the power source is turned off to stop power supply to the display apparatus. However, turning off the power source in this way causes the display apparatus to stop its operation. Accordingly, a user cannot see any of the various types of information on the display apparatus at all, which is very inconvenient for the user during traveling of the vehicle.

As described above, once the power source is turned off, the display apparatus cannot be used at all. Considering this, there are some display apparatuses which control the screen luminance in response to the ambient temperature to decrease the brightness of the backlight as the ambient temperature increases, thereby reducing the screen luminance. Thus reducing the screen luminance can decrease the heating value, and hence can suppress the internal temperature rise of the display apparatus.

However, since reducing the screen luminance will also decrease viewability, it is necessary for the user to stare at the screen to confirm the information (contents) displayed on the screen. As for the onboard display apparatus, in particular, it is not preferable for the driver to stare at the screen for securing safety.

On the other hand, there are some apparatuses that control the contrast of the LCD in response to the ambient temperature to improve the viewability, thereby preventing the reduction of the screen viewability (see Patent Document 1, for example). Furthermore, there are some apparatuses that reduces the driving voltage of a CRT when the internal temperature within the CRT increases, and carries out γ correction or color temperature correction of a video signal to compensate for the reduction of the driving voltage (that is, the reduction of the luminance) (see Patent Document 2, for example).
Patent Document 1: Japanese Utility Model Laid-Open No. 2-111118 (Pages 4-6, and FIG. 1)
Patent Document 2: Japanese Patent Laid-Open No. 6-22251 (Page 3 and FIG. 1)

The conventional display apparatuses are configured as described above, that is, configured in such a manner as to control the screen luminance in response to the internal temperature of the display apparatus, thereby suppressing the internal heat generation of the display apparatus and preventing the reduction of the viewability. However, the conventional display control units carry out only the video signal correction in such a manner as to perform the correction control of the contrast of the screen or to compensate for the luminance reduction in response to the ambient temperature. Therefore it has a problem in that the user cannot perform sufficient visual confirmation of the display contents when the screen luminance reduces greatly.

In other words, as for the conventional display apparatuses, if the luminance reduces greatly, there arises a problem in that even if the contrast correction or the video signal correction is made, the user cannot perform sufficient visual confirmation without staring at the contents displayed on the screen.

The present invention is implemented to solve the foregoing problem. Therefore it is an object of the present invention to provide a display apparatus capable of controlling the screen luminance in response to the ambient temperature, and of enabling the user to carry out the visual confirmation of the necessary information sufficiently even if the screen luminance reduces greatly.

### DISCLOSURE OF THE INVENTION

A display apparatus according to the present invention includes: a temperature detecting section for detecting temperature within the display apparatus at displaying various information items on a screen; a luminance correction control section for carrying out luminance correction control of a screen when the temperature detected by the temperature detecting section equals or exceeds a preset first temperature; and an information correction control section for carrying out screen display control by processing various information items when the temperature detected by the temperature detecting section equals or exceeds the first temperature.

According to the present invention, if the temperature detected by the temperature detecting section exceeds the first temperature, the luminance of the screen is reduced to decrease the heating value. In addition, since the various information items are processed before being displayed on the screen, even if the luminance of the screen is reduced, the necessary information is processed and displayed. Thus, the display apparatus offers an advantage of being able to maintain good viewability.

### BRIEF DESCRIPTION OF THE DRAWINGS

FIG. 1 is a block diagram showing a configuration of a display apparatus of an embodiment 1 in accordance with the present invention;

FIG. 2 is a block diagram showing another configuration of the display apparatus of the embodiment 1 in accordance with the present invention;

FIG. 3 is a flowchart illustrating the operation of the display apparatus of the embodiment 1 in accordance with the present invention;

FIG. 4 is a flowchart illustrating the normal display OFF control as shown in FIG. 3;

FIG. 5 is a flowchart illustrating the at-room temperature control as shown in FIG. 3;

FIG. 6 is a diagram illustrating an example of a backlight driving signal for driving the backlight shown in FIG. 1;

FIG. 7 is a table illustrating duty ratio settings in response to the temperature;

FIG. 8 is a graph illustrating variations of the duty ratio at individual temperatures versus brightness set points;

FIG. 9 is a diagram illustrating a display on an operating section when carrying out operation setting at a low temperature;

FIG. 10 is a flowchart illustrating the at-low temperature control as shown in FIG. 3;

FIG. 11 is a diagram illustrating a display on the operating section when carrying out operation setting at a high temperature;

FIG. 12 is a flowchart illustrating the at-high temperature control as shown in FIG. 3; and

FIG. 13 is a flowchart illustrating the forced display off control as shown in FIG. 3.

### BEST MODE FOR CARRYING OUT THE INVENTION

The best mode for carrying out the invention will now be described with reference to the accompanying drawings to explain the present invention in more detail.

### Embodiment 1

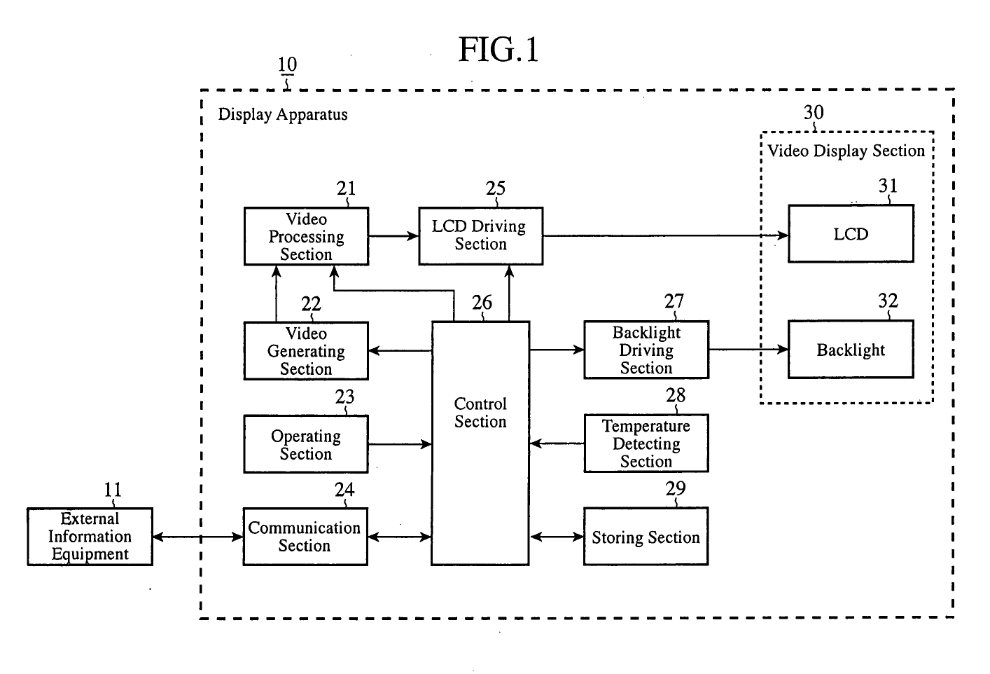

FIG. 1 shows a display apparatus of an embodiment 1 in accordance with the present invention. In FIG. 1, a display apparatus 10, which is mounted on a vehicle, for example, is connected to external information equipment 11 such as an audio system, an air conditioner ECU or an engine ECU, and displays various items of information obtained from the external information equipment 11. The display apparatus 10 includes a video processing section 21, a video generating section 22, an operating section 23, a communication section 24, an LCD driving section 25, a control section 26, a backlight driving section 27, a temperature detecting section 28, a storing section 29, and a video display section 30. The video display section 30 includes an LCD 31 and a backlight 32.

Although the display apparatus 10 is connected to the external information equipment 11 in the example of FIG. 1, the display apparatus 10 can sometimes be used alone. In this case, for example, the display apparatus 10 includes a television (TV) tuner and/or a DVD player, and the communication section 24 is not used (in other words, the communication section 24 is not essential). Then, the video generating section 22 generates a TV video or DVD playback video.

The external information equipment 11 provides the display apparatus 10 with external equipment information (such as traveling information, vehicle operation information, audio operation information, and maintenance information). The display apparatus 10 receives the external equipment information via the communication section 24, and delivers the external equipment information to the control section 26. As the communication section 24 is used a cable (such as RS-232C, USB, IEEE1394, CAN, LIN, or MOST) or a wireless (such as IRDA, Bluetooth (registered trademark), or DSRC).

A user can make user settings which will be described later through the operating section 23. As the operating section 23, hard-keys, a touch screen, a remote control or a voice input device can be used. Then, the control section 26 stores the user settings in the storing section 29 as user set information. The storing section 29 stores various control information items in advance. According to the user set information, the various control information items and the temperature detected by the temperature detecting section 28, the control section 26 controls the video processing section 21, LCD driving section 25, and backlight driving section 27 in a manner that will be described later.

The external equipment information is delivered from the control section 26 to the video generating section 22. The video generating section 22 generates a video signal corresponding to the external equipment information, and supplies the information image to the video processing section 21. The video processing section 21 carries out display processing for displaying the video signal under the control of the control section 26. In this case, it carries out, for example, contour correction, contrast correction, gray level correction, and/or color correction in such a manner as will be described later. Then, according to the video signal passing through the display processing, the LCD driving section 25 drives the LCD 31 to display the image corresponding to the external equipment information on the LCD 31. On the other hand, under the control of the control section 26, the backlight driving section 27 drives the backlight 32 to turn on and off the backlight to adjust its illuminance.

Incidentally, when the user carries out the setting for the external information equipment 11 through the operating section 23, the control section 26 delivers the user setting to the external information equipment 11 via the communication section 24.

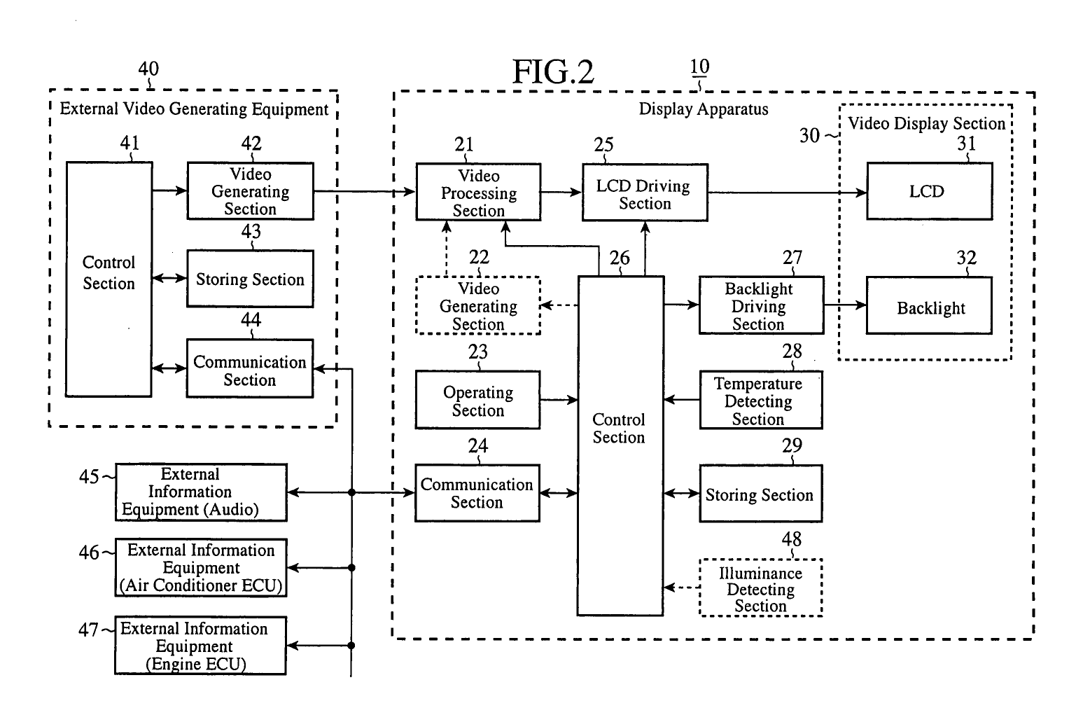

FIG. 2 is a block diagram showing the display apparatus 10 as shown in FIG. 1, which is used in conjunction with external video generating equipment (such as a navigation unit) 40. In FIG. 2, the same components as those of FIG. 1 are designated by the same reference numerals. The external video generating equipment 40 includes a control section 41, a video generating section 42, a storing section 43, and a communication section 44. In addition, in the example shown in FIG. 2, an audio system, an air conditioner ECU, and an engine ECU are connected to the display apparatus 10 as external information equipment 45-47. As shown by a broken line block, the display apparatus 10 can comprise an illuminance detecting section 48 for detecting the illuminance in the environment.

As described above in connection with FIG. 1, the external information equipment 45-47 supplies the display apparatus 10 with the external equipment information via the communication section 24, and the external equipment information is displayed on the LCD 31. On the other hand, in the external video generating equipment 40, under the control of the control section 41 and according to the control data (such as map data) stored in the storing section 43, the video generating section 42 generates a navigation video signal, for example, and supplies it to the video processing section 21. Thus, the LCD 31 displays a picture corresponding to the navigation video signal as described above.

Incidentally, when the user carries out the setting for the external video generating equipment 11 through the operating section 23, the control section 26 delivers the user setting to the external video generating equipment 11 via the communication section 24. In addition, the external video generating equipment 40 may sometimes include a TV tuner or a DVD player. Furthermore, as shown by a broken line block in FIG. 2, the display apparatus 10 need not comprise the video generating section 22. In this case, the external equipment information from the external information equipment 45-47 is supplied to the control section 41 via the communication section 44, and the video generating section 42 generates the video signal corresponding to the external equipment information under the control of the control section 41.

Next, the operation will be described.

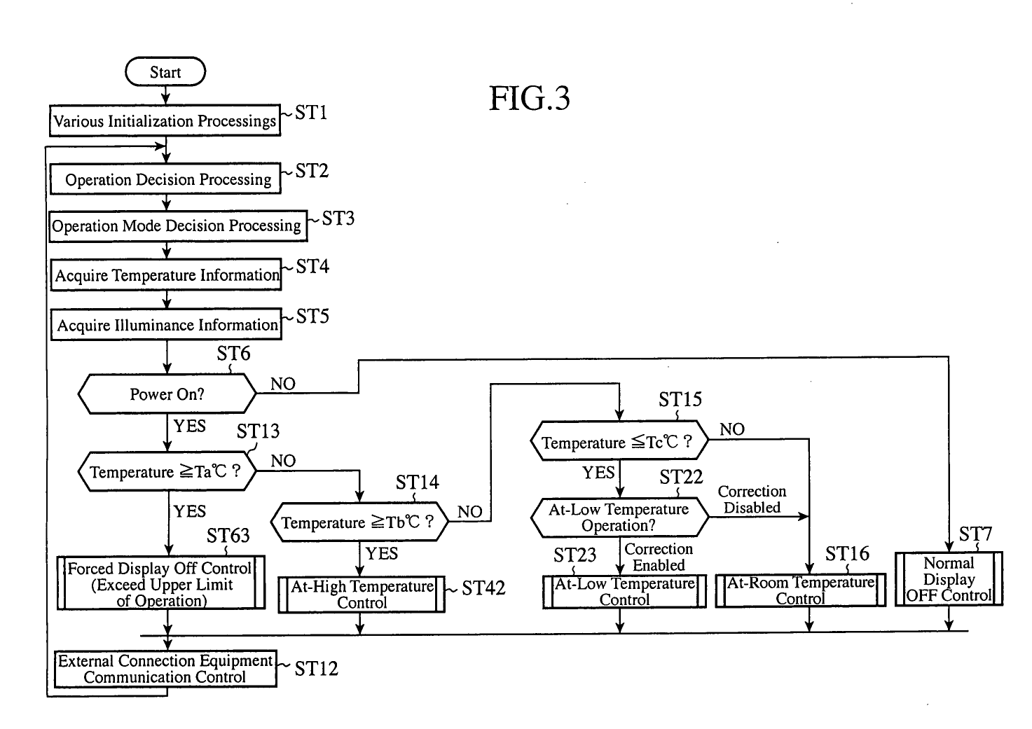

Referring to FIG. 1 and FIG. 3, the control section 26 carries out initialization processing, first (step ST1). The initialization processing performs initialization of variables and flags used for the control, for example. Subsequently, the control section 26 detects the user setting through the operating section 23, attaches a meaning to the user setting (operation decision processing: step ST2), and stores it into the storing section 29 as the user set information. Furthermore, the control section 26 decides the operation mode in response to the manipulation of the operating section 23 (step ST3: turn on or off the screen, for example).

Next, the control section 26 acquires the detected temperature from the temperature detecting section 28 as the ambient temperature (step ST4). The storing section 29 includes a detection signal-temperature characteristic table indicating relationships between the detection signal (voltage signal) output from the temperature detecting section 28 and the temperature, for example, and the control section 26 obtains the ambient temperature in accordance with the temperature characteristic table. Then, although not shown in FIG. 1, the control section 26 acquires, as the illuminance information, environmental illuminance about the display apparatus 10 from an illuminance detecting section provided in the vehicle (step ST5). The storing section 29 includes a detection signal-illuminance characteristic table indicating relationships between the detection signal (voltage signal) output from the illuminance detecting section and the illuminance, for example, and the control section 26 obtains the environment illuminance of the display apparatus in accordance with the illuminance characteristic table.

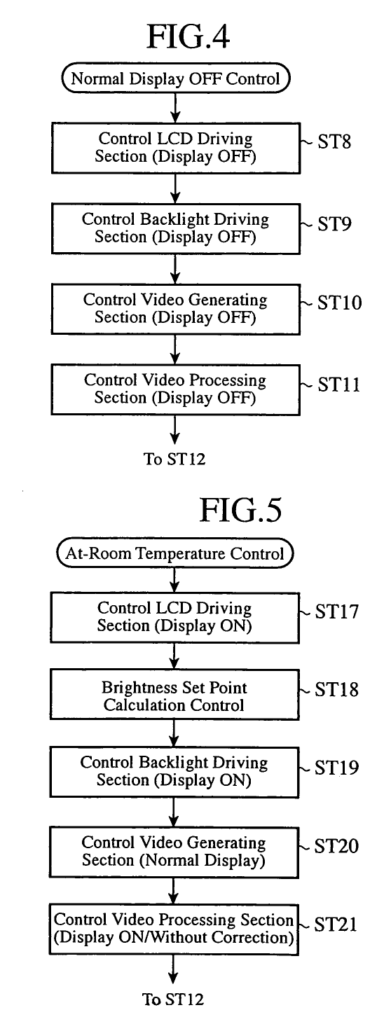

Acquiring the ambient temperature as described above, the control section 26 makes a decision as to whether the power is to be turned on or not (step ST6). If the power is to be turned off, the control section 26 carries out normal display OFF setting (normal display OFF control) (step ST7). FIG. 4 is a flowchart illustrating the normal display OFF control. The control section 26 controls the LCD driving section 25 to turn it off (step ST8), and turns off the backlight driving section 27 (step ST9). Subsequently, the control section 26 controls the video generating section 22 to turn it off (step ST10), and turns off the video processing section 21 as well (step ST11). Then, the control section 26 notifies the external information equipment 11 that it carries out the normal display OFF control (external connection equipment communication control: step ST12).

On the other hand, if the power is to be turned on at step ST6, the control section 26 makes a decision as to whether the ambient temperature is equal to or higher than the prescribed temperature (inoperable temperature (second temperature)) Ta° C. or not (step ST13). If the ambient temperature <Ta at step ST13, the control section 26 makes a decision as to whether the ambient temperature is equal to or higher than a temperature Tb° C. (first temperature (where Tb<Ta)) or not (step ST14). If the ambient temperature <Tb at step ST14, the control section 26 makes a decision as to whether the ambient temperature is equal to or lower than a temperature Tc° C. (third temperature (where Tc<Tb)) or not (step ST15). If the ambient temperature >Tc, that is, if it falls in a range Tc<ambient temperature<Tb (room temperature range), the control section 26 carries out at-room temperature processing (step ST16).

FIG. 5 is a flowchart illustrating the at-room temperature control. The control section 26 controls the LCD driving section 25 to turn it on (step ST17), and carries out brightness setting operation (step ST18). In the brightness setting operation, the control section 26 corrects the duty ratio in accordance with the ambient temperature to suppress the heat generation.

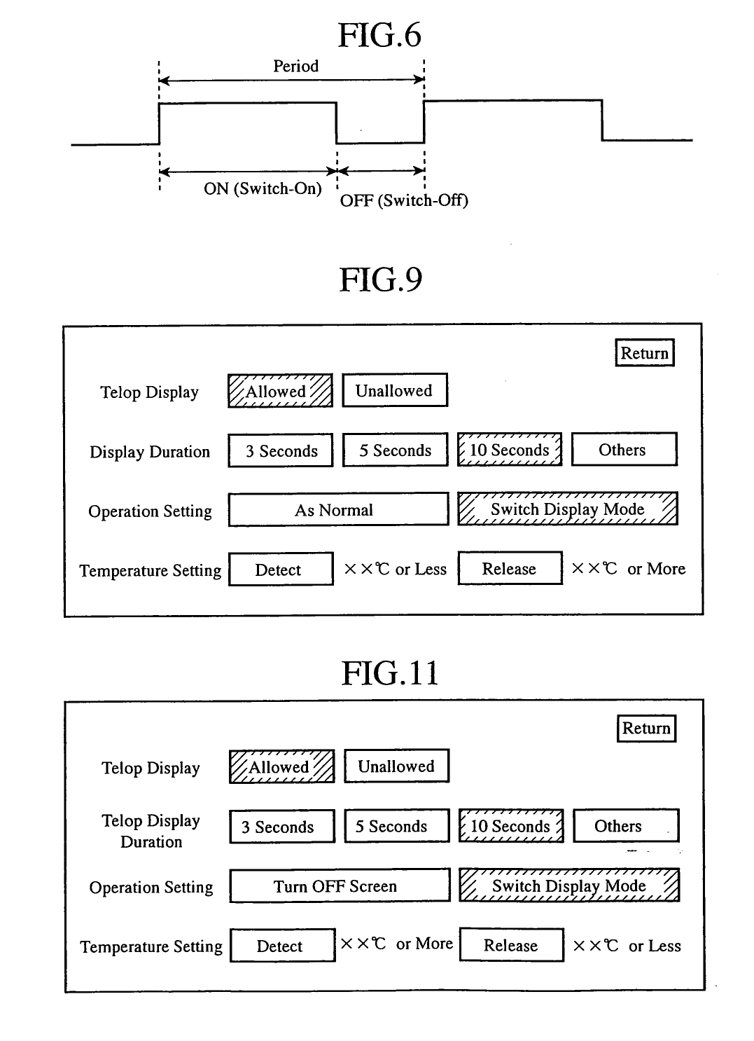

Here, the backlight 32 is driven by the backlight driving signal (driving waveform) from the backlight driving section 27, which is a pulse signal as shown in FIG. 6. Thus, when the backlight driving signal is in the ON state, the backlight 32 is on, whereas when the backlight driving signal is in the OFF state, the backlight 32 is off. Since the brightness of the screen (that is, the luminance) is determined by the duty ratio (ON duration÷(ON duration+OFF duration)×100%) of the backlight driving signal, the screen becomes brighter as the ratio of the ON duration increases in the period of the backlight driving signal. Then, the brighter the backlight 32, the greater the internal heating value of the display apparatus 10.

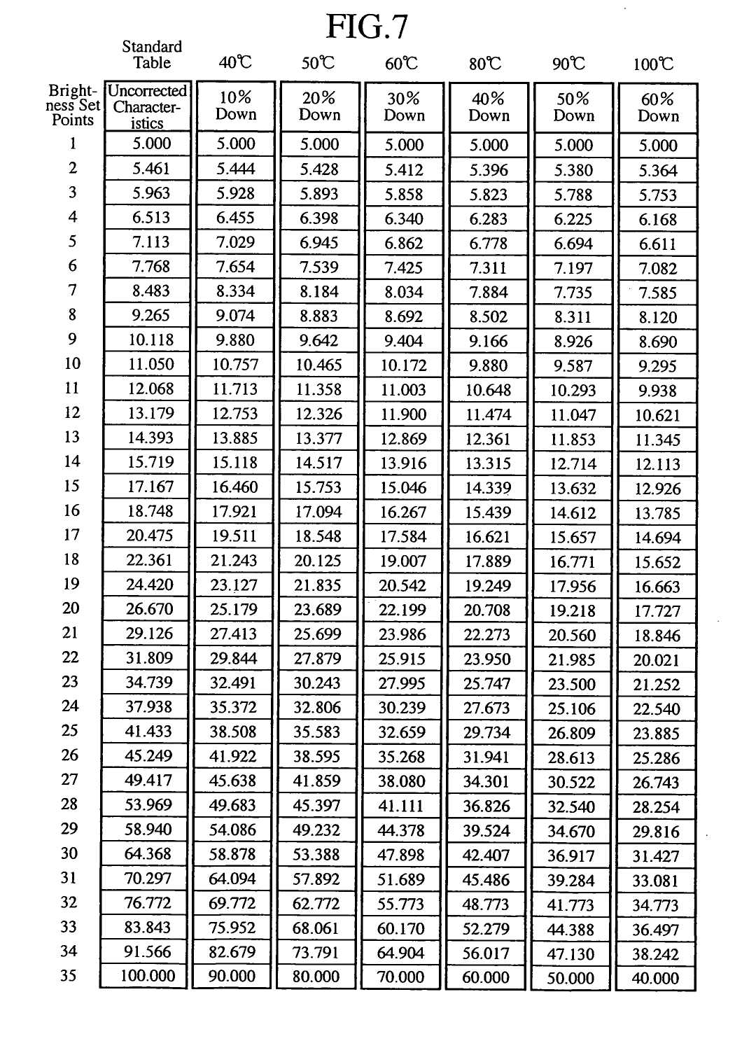

The storing section 29 stores correction data indicating correction amounts of the duty ratios together with standard data as a duty table. For example, as shown in FIG. 7, as for the duty ratio settings (brightness set points) 1-35, the standard data and the correction data for temperatures 40° C., 50° C., 60° C., 80° C., 90° C., and 100° C. are stored. In the example of FIG. 7, when the duty ratio of the standard data is determined at 100% for the setting 35, the correction data at temperature 40° C. is reduced by 10% to 90%, and the correction data at temperature 50° C. is reduced by 20% to 80%.

Likewise, the correction data at temperature 60° C. is reduced by 30% to 70%, the correction data at temperature 80° C. is reduced by 40% to 80%, the correction data at temperature 90° C. is reduced by 50% to 50%, and the correction data at temperature 100° C. is reduced by 60% to 40%. At the settings other than the setting 35, the reduction ratios to the standard data are smaller than those of the setting 35. For example, at setting 1, the duty ratio is set at 5% for all the standard data and correction data.

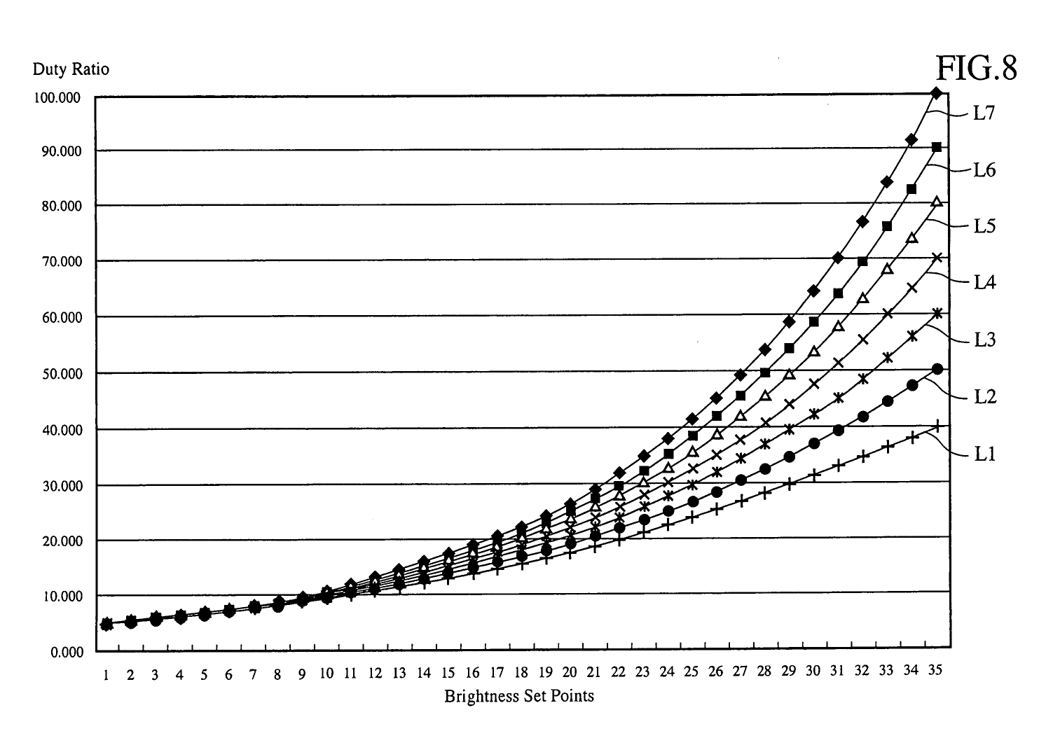

Thus, as for the standard data and correction data, although their duty ratios increase curvilinearly from the setting 1 toward setting 35 as illustrated in FIG. 8, the increasing rate is minimum in the correction data of the temperature 100° C. In a region where the duty ratios are small, even if the ambient temperature varies, the heat generation suppressing effect is small, and according to human visual characteristics, small changes in brightness are perceived as great changes. Thus, the variations of the duty ratios in accordance with the ambient temperature are made small. In FIG. 8, L1 corresponds to 60% down, L2 to 50% down, L3 to 40% down, L4 to 30% down, L5 to 20% down, L6 to 10% down, and L7 corresponds to uncorrected characteristics, respectively.

As for the foregoing brightness setting, the user carries it out as the user set information. In the brightness setting operation, the control section 26 decides the duty ratio corresponding to the ambient temperature and brightness setting. Then, the control section 26 delivers the driving control signal including the decided duty ratio to the backlight driving section 27. In response to the backlight driving signal corresponding to the driving control signal, the backlight driving section 27 drives the backlight 32.

Although FIG. 7 and FIG. 8 illustrate only the standard data and the correction data at temperatures 40° C., 50° C., 60° C., 80° C., 90° C., and 100° C., actual temperature divisions are narrower so that a lot of correction data are set in the storing section 29. Furthermore, it is also possible for the storing section 29 to store a calculating expression for obtaining the duty ratio for each temperature and user setting instead of the standard data and correction data, and for the control section 26 to determine the duty ratio based on the calculating expression. The calculating expression is given by the following expression, for example.

$$D ( n ) = EXP ( LN ( D ( Min ) ) + ( \begin{matrix}LN ( D ( Max ) ) - LN ( D ( Min ) ) + \\ ( the number of steps - 1 ) \times ( n - 1 )\end{matrix} )$$

where D(n) is the duty ratio at the number of steps (brightness set point number) n; D (Min) is the minimum value of the duty ratio (fixed to 5% at each temperature); D (Max) is the maximum value of the duty ratio (variable (100%-40%) at each temperature, and can be calculated from the temperature by an expression. For example, D (Max)=(100−K×(T−T0)), where K is a coefficient, T is the temperature, T0 is the temperature in an uncorrected case. Assume that the temperature=80° C., the temperature in the uncorrected case=30° C., and K=1.0, then D (Max)=50%. The number n is 1, 2, 3, . . . 35; EXP(x) is the exponential function raising e to the power of x; LN(x) is a logarithm of x to the base e; and the number of steps is the number of the brightness set points in the luminance table (35 in the example shown in FIG. 7).

After determining the duty ratio through the brightness set point calculation control, the control section 26 controls the backlight driving section 27 as described above (step ST19). After that, the control section 26 carries out normal display with controlling the video generating section 22 (step ST20), and brings the video processing section 21 into the ON state (without correction) (step ST21). Subsequently, at step ST12, the control section 26 notifies the external information equipment 11 that it performs the at-room temperature control.

At step ST15, if the ambient temperature ≦Tc, the control section 26 makes a decision of low temperature, and decides on whether to carry out the at-low temperature operation (at-low temperature control) or not (step ST22). As to whether to carry out the at-low temperature control or not, the user sets through the operating section 23. FIG. 9 is a diagram illustrating the control screen for the at-low temperature control setting (operation setting at the low temperature). The at-low temperature control setting includes “telop display”, “display duration”, “operation setting”, and “temperature setting”. The “telop display” has “allowed” and “unallowed” modes, and when the “allowed” mode is set, a telop indicative of performing the at-low temperature control is run on the LCD 31.

Then the telop is run during the time set by the “display duration”. The “operation setting” has two modes of “as normal” and “switch display mode”. When the “switch display mode” is set, switching is made to a video providing good viewability of the LCD 31 as will be described later, and when the “as normal” is set, normal video display is performed. In addition, in the “temperature setting”, are set the detected temperature (detection) and release temperature (release).

At step ST22, when the at-low temperature operation is set (correction enabled), the control section 26 carries out the at-low temperature control (step ST23). In contrast, unless the at-low temperature operation is set (correction disabled), the control section 26 proceeds to step ST16 to perform the foregoing at-room temperature control.

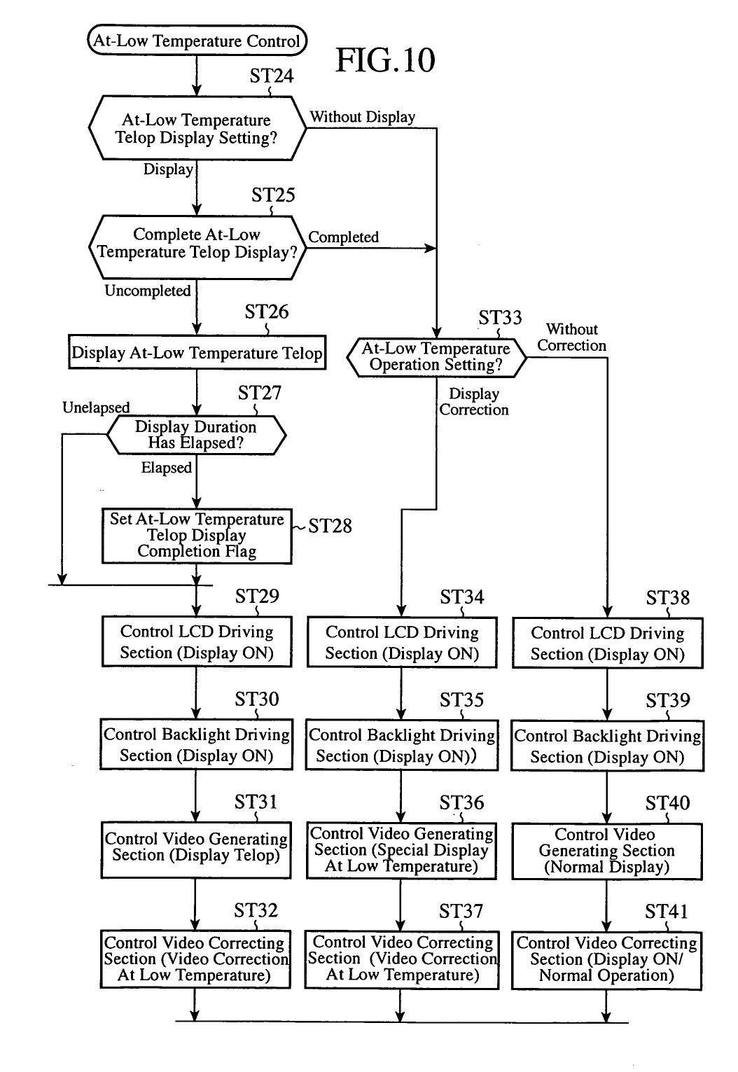

FIG. 10 is a flowchart illustrating the at-low temperature control. First, the control section 26 makes a decision as to whether the at-low temperature telop display setting is present or not (step ST24). If the telop display setting is present, it makes a decision as to whether the at-low temperature telop display has already been completed or not (step ST25). If it has not yet been completed, the control section 26 carries out the at-low temperature telop display (step ST26). Subsequently, the control section 26 makes a decision as to whether the display duration has elapsed or not (step ST27). If the display duration has elapsed, after setting the at-low temperature telop display completion flag (step ST28), the control section 26 controls the LCD driving section 25 to turn it on (step ST29), and controls the backlight driving section 27 to turn it on (step ST30).

After that, the control section 26 controls the video generating section 22 to run the telop (step ST31), and controls the video processing section 21 to carry out the video correction at the low temperature (which will be described later) (step ST32). Then, at step ST12, the control section 26 notifies the external information equipment 11 that it performs the at-low temperature control. At step ST27, if the display duration has not yet been completed, the control section 26 proceeds to step ST29.

On the other hand, making a decision at step ST24 that the at-low temperature telop display setting is absent, or at step ST25 that the at-low temperature telop display has been completed, the control section 26 makes a decision as to whether the at-low temperature operation setting has been made or not (step ST33). If the “display correction (switch display mode)” is set, the control section 26 controls the LCD driving section 25 to turn it on (step ST34), and controls the backlight driving section 27 to turn it on (step ST35). After that, the control section 26 controls the video generating section 22 to perform a special display at the low temperature (step ST36), and controls the video processing section 21 to carry out the video correction at the low temperature (step ST37). Then, at step ST12, the control section 26 notifies the external information equipment 11 that it carries out the at-low temperature control.

At step ST33, when “without correction (as normal)” is set, the control section 26 controls the LCD driving section 25 to turn it on (step ST38), and controls the backlight driving section 27 to turn it on (step ST39). After that, the control section 26 controls the video generating section 22 to perform the normal display (step ST40), and controls the video processing section 21 to turn it on (step ST41). Then, at step ST12, the control section 26 notifies the external information equipment 11 that it carries out the at-low temperature control.

At step ST14, if the ambient temperature ≧Tb, that is, if Tb≦ambient temperature<Ta, the control section 26 considers it to be a high temperature detection range, and carries out the at-high temperature control (step ST42). As for the at-high temperature control, the user sets it through the operating section 23. FIG. 11 is a diagram illustrating the control screen for the at-high temperature control setting (operation setting at the high temperature). The at-high temperature control setting includes “telop display”, “telop display duration”, “operation setting”, and “temperature setting”. The “telop display” has “allowed” and “unallowed” modes, and when the “allowed” mode is set, a telop indicative of performing the at-high temperature control is run on the LCD 31.

Thus, the telop is run during the time set by the “telop display duration”. The “operation setting” has two modes of “turn off screen” and “switch display mode”. When the “switch display mode” is set, switching is made to a video providing good viewability of the LCD 31 as will be described later, and when the “turn off screen” is set, the screen is turned off as will be described later. In addition, in the “temperature setting”, are set the detected temperature (detection) and release temperature (release).

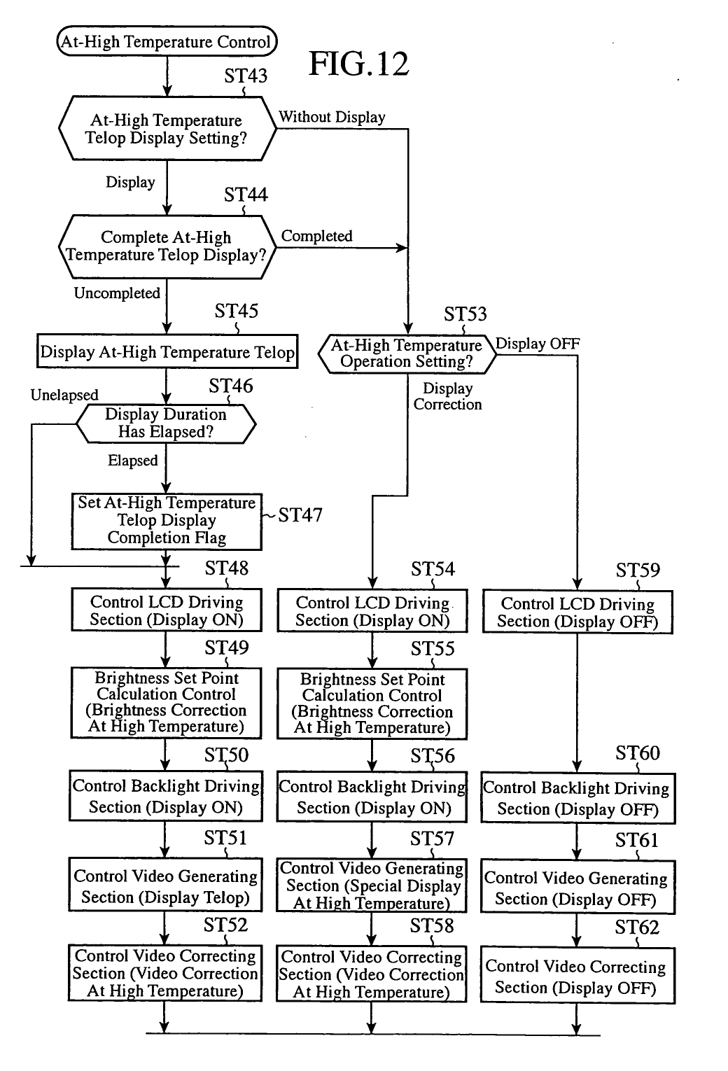

FIG. 12 is a flowchart illustrating the at-high temperature control. First, the control section 26 makes a decision as to whether the at-high temperature telop display setting is present or not (step ST43). If the telop display setting is present, it makes a decision as to whether the at-high temperature telop display has already been completed or not (step ST44). If it has not yet been completed, the control section 26 carries out the at-high temperature telop display (step ST45). Subsequently, the control section 26 makes a decision as to whether the display duration has elapsed or not (step ST46). If the display duration has elapsed, after setting the at-high temperature telop display completion flag (step ST47), the control section 26 controls the LCD driving section 25 to turn it on (step ST48), carries out the brightness set point calculation control (step ST49), and controls the backlight driving section 27 to turn it on (step ST50).

After that, the control section 26 controls the video generating section 22 to run the telop (step ST51), and controls the video processing section 21 to carry out the video correction at the high temperature (step ST52). Then, at step ST12, the control section 26 notifies the external information equipment 11 that it performs the at-high temperature control. At step ST46, if the display duration has not yet been completed, the control section 26 proceeds to step ST48.

On the other hand, making a decision at step ST43 that the at-high temperature telop display setting is absent, or at step ST44 that the at-high temperature telop display has been completed, the control section 26 makes a decision as to whether the at-high temperature operation setting has been made or not (step ST53). If the “display correction (switch display mode)” is set, the control section 26 controls the LCD driving section 25 to turn it on (step ST54), carries out the brightness set point calculation control (step ST55), and controls the backlight driving section 27 to turn it on (step ST56). After that, the control section 26 controls the video generating section 22 to perform a special display at the high temperature (step ST57), and controls the video processing section 21 to carry out the video correction at the high temperature (step ST58). Then, at step ST12, the control section 26 notifies the external information equipment 11 that it carries out the at-high temperature control.

At step ST53, when the “turn off screen (display off)” is set, the control section 26 controls the LCD driving section 25 to turn it off (step ST59), and controls the backlight driving section 27 to turn it off (step ST60). After that, the control section 26 controls the video generating section 22 to turn it off (step ST61), and controls the video processing section 21 to turn it off (step ST62). Then, at step ST12, the control section 26 notifies the external information equipment 11 that it carries out the at-high temperature control.

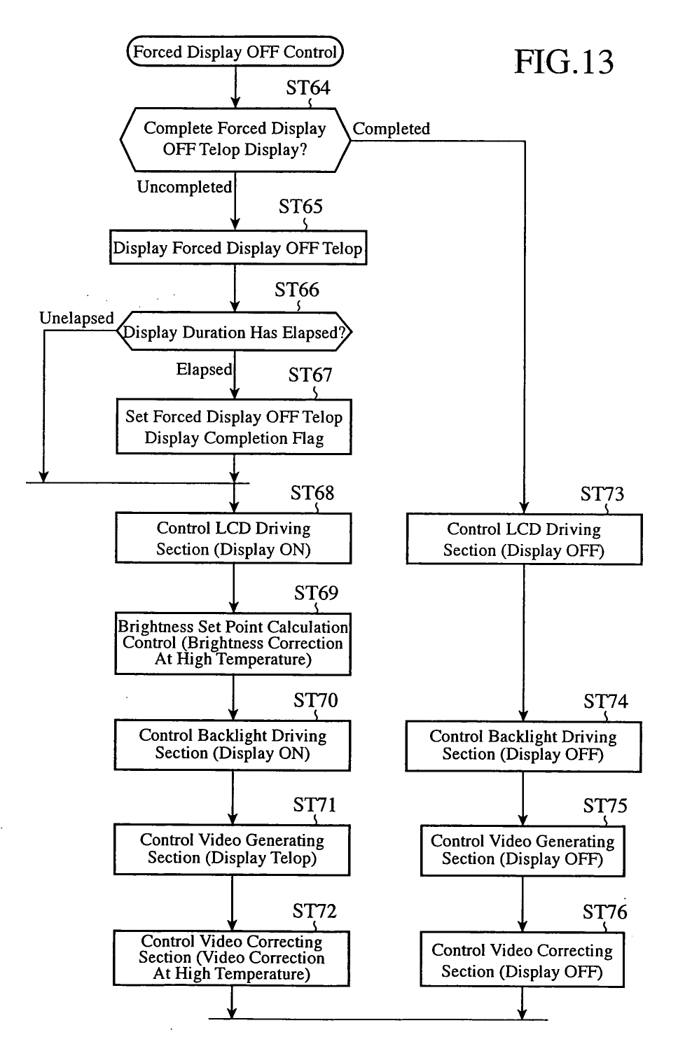

At step ST13 shown in FIG. 3, if the ambient temperature ≧Ta, the control section 26 carries out the forced display off control (step ST63). FIG. 13 is a flowchart illustrating the forced display off control. First, the control section 26 makes a decision as to whether the forced display off telop display has already been completed or not (step ST64). If it has not yet been completed, the control section 26 runs the forced display off telop (step ST65). Subsequently, the control section 26 makes a decision as to whether the display duration has elapsed or not (step ST66). If the display duration has elapsed, after setting the forced display off telop display completion flag (step ST67), the control section 26 controls the LCD driving section 25 to turn it on (step ST68), carries out the brightness set point calculation control (step ST69), and controls the backlight driving section 27 to turn it on (step ST70).

After that, the control section 26 controls the video generating section 22 to run the telop (step ST71), and controls the video processing section 21 to carry out the video correction at the high temperature (step ST72). Then, at step ST12, the control section 26 notifies the external information equipment 11 that it performs the forced display off control. At step ST66, if the display duration has not yet been completed, the control section 26 proceeds to step ST68.

On the other hand, making a decision at step ST64 that the forced off telop display has been completed, the control section 26 controls the LCD driving section 25 to turn it off (step ST73), and controls the backlight driving section 27 to turn it off (step ST74). In addition, the control section 26 controls the video generating section 22 to turn it off (step ST75), and controls the video processing section 21 to turn it off (step ST76). Then, at step ST12, the control section 26 notifies the external information equipment 11 that it carries out the forced display off control.

Here, the screen display at the high temperature will be described. At the high temperature, the brightness of the backlight is controlled as described before to darken the screen (reduce the luminance), thereby suppressing the heat generation. However, as the luminance is reduced, the viewability of the information (such as letters, characters and symbols) on the screen is reduced. Considering this, to increase the viewability, the special display and video correction are carried out. Here, the information to be displayed on the LCD 31 is limited in its volume, and is switched to a high-visibility layout display.

For example, when the map is displayed, narrow streets on the map are deleted, and on the control information screen such as of the audio or air conditioner, minimum necessary information is displayed. Furthermore, sizes of characters and diagrams are changed to a high-visibility screen layout. For example, font sizes, thickness of lines in the map, and sizes of icons and marks are changed. In addition, the screen color scheme is altered to a high-visibility screen layout. For example, similar colors are avoided and edging is added.

More specifically, as for the map screen, the following screen corrections are performed to improve the viewability at the reduction of the luminance: deleting the narrow streets on the map and displaying only principal roads; altering thicknesses of the roads; changing the reduced scale; changing the number of facilities to be displayed and the number of place-names to be displayed; increasing the size of icons and font sizes of characters; making the characters bolder; changing colors of the characters and background of the map; adding edging; and switching to a route map.

In addition, as for various information screens such as about traveling information, vehicle operation information, audio screen, or maintenance information, the following screen corrections are performed to improve the viewability at the reduction of the luminance: displaying only minimum necessary information that is set in advance; increasing the size of icons and font sizes of characters; making the characters bolder; changing colors of the characters and background of the screen; and adding edging.

As for the TV screen, DVD screen, and camera video, the following screen corrections are performed to improve the viewability at the reduction of the luminance: contour emphasis; contrast enhancement; and gray level correction and color correction. Such processing of information is carried out in the at-low temperature control as described above.

As is clear from the foregoing description, the control section 26 and backlight driving section 27 function as a luminance correction control section, and the control section 26, video generating section 22, video processing section 21, and LCD driving section 25 function as an information correction control section and telop display control section.

As described above, the present embodiment 1 is configured in such a manner as to control the backlight 32 when the temperature within the display apparatus 10 increases in order to reduce the luminance of the LCD 31 and to suppress the heating value, and as to process the information to be displayed on the LCD 31. Thus, the present embodiment can prevent the deterioration of the viewability. In particular, it can prevent danger involved in the deterioration of the viewability during driving.

The present embodiment 1 is configured in such a manner that when the temperature within the display apparatus 10 becomes high or low temperature, after running the telop on the screen, it carries out the processing and/or luminance correction of the information to be displayed on the screen. Thus, the user can recognize in advance that the screen display will be changed. Accordingly, the present embodiment 1 can prevent the user from making the mistake of thinking that a failure takes place when the screen display changes suddenly.

The present embodiment 1 is configured in such a manner that if the screen display off is set when the temperature within the display apparatus 10 becomes high, it turns off the screen display. Accordingly, it can reduce damages of the internal components of the display apparatus 10 because of the high temperature.

The present embodiment 1 is configured in such a manner as to turn off the screen display by force when the internal temperature of the display apparatus 10 exceeds the upper limit temperature of the operation. Thus, it can circumvent a failure of the display apparatus 10. In addition, at the forced display off processing, since it runs a telop indicative of carrying out the forced display off processing on the screen display, the user can recognize in advance that the power source will be turned off.

### INDUSTRIAL APPLICABILITY

The present invention is widely applicable to display apparatuses that are mounted on vehicles and the like, and that must prevent deterioration of the viewability during driving.

What is claimed is:

1. A display apparatus comprising:
a temperature detecting section for detecting temperature within the display apparatus;
a luminance correction control section for carrying out luminance correction control of a screen when the temperature detected by said temperature detecting section equals or exceeds a preset first temperature; and
an information correction control section for carrying out screen display control by processing various information items when the temperature detected by said temperature detecting section equals or exceeds the first temperature.

2. The display apparatus according to claim 1, further comprising a display control section for making a display indicating that the luminance correction control and the screen display control are be carried out if the temperature detected by said temperature detecting section is equal to or greater than the first temperature.

3. The display apparatus according to claim 1, further comprising a display off control section for turning off a screen display when screen display off is set at a time when the temperature detected by said temperature detecting section is equal to or greater than the first temperature.

4. The display apparatus according to claim 1, wherein said information correction control section processes the various information items to improve viewability during screen display.

5. The display apparatus according to claim 3, wherein said display off control section performs forced display off processing that turns off the screen display by force if the temperature detected by said temperature detecting section is equal to or greater than a second temperature higher than the first temperature.

6. The display apparatus according to claim 5, further comprising a display control section for making a display indicating that the forced display off processing is to be carried out at the forced display off processing.

7. The display apparatus according to claim 1, wherein said information correction control section carries out, when the temperature detected by said temperature detecting section is equal to or lower than a third temperature that is equal to or lower than the first temperature, the screen display control by processing the various information items.

8. The display apparatus according to claim 7, further comprising a display control section for making a display indicating that the screen display control is to be carried out at the screen display control.
